(19) United States
(12) Patent Application Publication
(10) Pub. No.: US 2025/0217097 A1
(43) Pub. Date: Jul. 3, 2025

(54) REMOTE GESTURE CONTROL, INPUT MONITOR, SYSTEMS INCLUDING THE SAME, AND ASSOCIATED METHODS

(71) Applicant: KARL STORZ SE & Co. KG, Tuttlingen (DE)

(72) Inventors: James E. MORRIS, Lake Wylie, SC (US); Michael R. FELDMAN, Huntersville, NC (US)

(73) Assignee: KARL STORZ SE & Co. KG, Tuttlingen (DE)

(21) Appl. No.: 18/948,038

(22) Filed: Nov. 14, 2024

Related U.S. Application Data
(63) Continuation of application No. 17/706,606, filed on Mar. 29, 2022, now abandoned.
Application No. 17/706,606 is a continuation of application No. 15/184,814, filed on Jun. 16, 2016, now abandoned.
(60) Provisional application No. 62/180,508, filed on Jun. 16, 2015.

(51) Int. Cl. G06F 3/14; G06F 3/0482; G06F 3/0488; H04L 65/401

(52) U.S. Cl. CPC G06F 3/1454; G06F 3/0482; G06F 3/0488; H04L 65/4015; G09G 2370/16

(57) ABSTRACT

A system includes a common display, a display computer that drives the common display and runs collaboration software, and a mobile device to run a sharing application and a streaming application. A wireless connection is established between the mobile device and the display computer through the sharing application on the mobile device and entering an identifier associated with the display computer. The mobile device displays a video signal. The streaming application converts this video signal to a digital stream and the display computer displays the digital stream in a mobile device window on the common display and when a gesture input associated with the mobile device window is detected, the display computer sends the gesture to the mobile device. The mobile device changes the first digital stream in response to the gesture and then updated first digital stream is displayed in the mobile device window on the common display.

### CROSS-REFERENCE TO RELATED APPLICATIONS

The present application is a continuation of U.S. patent application Ser. No. 17/706,606, filed on Mar. 29, 2022, which is a continuation of U.S. patent application Ser. No. 15/184,814, filed on Jun. 16, 2016, and entitled “REMOTE GESTURE CONTROL, INPUT MONITOR, SYSTEMS INCLUDING THE SAME, AND ASSOCIATED METHODS,” and claims priority under 35 U.S.C. § 119(e) to U.S. Provisional Application No. 62/180,508, filed on Jun. 16, 2015, and entitled: “Simultaneous Input System for Web Browsers and Other Applications,” the entire content of each are incorporated herein by reference in their entirety.

### BACKGROUND

As disclosed in U.S. patent application Ser. No. 15/056,787, filed Feb. 29, 2016, and entitled “SYSTEM FOR CONNECTING A MOBILE DEVICE AND A COMMON DISPLAY”, now U.S. Pat. No. 10,616,632, which is hereby incorporated by reference in its entirety for all purposes, the Display Computer would receive data from the mobile device (MD) to mirror the screen on the common display (CD) in a mobile device window (MDW). A snapshot of the MDW could be taken and stored on the CD. Thus, the snapshot could be transmitted from the Display Computer back to the mobile device, for example as a PDF, and not affecting the original data on the MD. Thus, the information may be captured by the MD, but not automatically updated on the MD.

### SUMMARY

One or more embodiments are directed to a system including a common display, a display computer that drives the common display, the display computer to run collaboration software, and a first mobile device to run a sharing application and a streaming application. A wireless connection is established between the first mobile device and the display computer through the sharing application on the mobile device and entering an identifier associated with the display computer. The first mobile device has a video signal displayed on its screen and the streaming application converts this video signal to a first digital stream. The display computer displays a first digital stream in a first mobile device window on the common display and detects a gesture input associated with the first mobile device window. The display computer sends the gesture to the mobile device and the mobile device changes the video signal in response to the gesture and then the first digital stream is changed to reflect the change in the video signal and then updated digital stream is displayed in the first mobile device window on the common display.

One or more embodiments are directed to a system including a common display, a display computer that drives the common display, the display computer to run collaboration software, a first mobile device to output a first data stream, a digitizer between the first mobile device and the display computer, the digitizer receiving the first data stream from the first mobile device and output a first digital data stream to the display computer, and a connection interface between the display computer and the first mobile device. The display computer displays the first digital stream in a first mobile device window on the common display and detects a gesture input associated with the first mobile device window, the display computer sends the gesture input to the connection interface, and the connection interface changes the first digital stream to reflect the change in the video signal, outputs the updated digital stream to the first mobile device and the first mobile device displays the updated video stream on the first mobile device.

One or more embodiments are directed to a system including a common display, a display computer that drives the common display, the display computer to run collaboration software, a first mobile device to output a first data stream, and a second mobile device to output a second data stream. The display computer displays a first digital stream in a first mobile device window on the common display and displays a second digital data stream in a second mobile device window. When the display computer detects a gesture input associated with the first mobile device window, the display computer sends the gesture to the first mobile device and the first mobile device changes the video signal in response to the gesture and then the first digital stream is changed to reflect the change in the video signal and then updated first digital stream is displayed in the first mobile device window on the common display. When the display computer detects a gesture input associated with the second mobile device window, the display computer sends the gesture to the second mobile device and the second mobile device changes the video signal in response to the gesture and then the second digital stream is changed to reflect the change in the video signal and then updated second digital stream is displayed in the second mobile device window on the common display.

One or more embodiments are directed to a system including a common display, a display computer that drives the common display, the display computer to run collaboration software, and a first mobile device to output a first data stream. The display computer is to display the first digital stream in a first mobile device window on the common display and monitor an output from the first mobile device. When a standard deviation between pixels of the first digital stream from the first mobile device is below a predetermined threshold, the display computer is to stop displaying the first digital stream.

### BRIEF DESCRIPTION OF THE DRAWINGS

Features will become apparent to those of skill in the art by describing in detail exemplary embodiments with reference to the attached drawings in which:

FIG. 1 illustrates a block diagram of a display system in accordance with an embodiment;

FIG. 2 illustrates a top view of the horizontal display of FIG. 1;

FIG. 3 illustrates a block diagram of a display system in accordance with an embodiment;

FIG. 4 illustrates a block diagram of a display system in accordance with an embodiment;

FIG. 5 illustrates a flowchart in accordance with an embodiment;

FIG. 6 illustrates a screenshot of a system according to an embodiment;

FIG. 7 illustrates a flowchart in accordance with an embodiment;

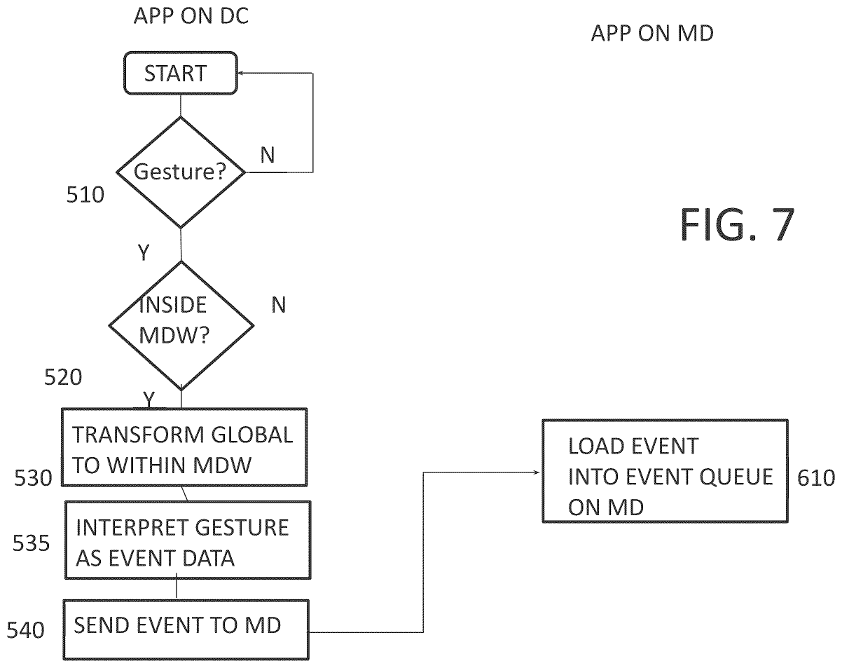

FIG. 8 illustrates a flowchart in accordance with an embodiment;

FIG. 9 illustrates schematic views of a common display with mobile device windows and associated trays in accordance with an embodiment; and

FIG. 10 illustrates a screen on a mobile device in accordance with an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

One or more embodiments described herein are directed to using monitoring inputs, e.g., hardline inputs or wireless inputs, from a mobile device to a display computer.

One or more embodiments described herein are directed to how users using a common display can manipulate data and/or control a mobile device through the display computer, herein Remote Gesture Control (RGC), e.g., in which a gesture input action, such as a touch, e.g., direct touch, or a non-touch gesture near (camera(s) monitoring) or otherwise coupled to (gloves, wristbands, and so forth), on a first screen connected to and controlled by a first computer is communicated and replicated on another screen controlled by a second computer. The display computer would be running collaboration software that enables multiple users to stream, share, view, and manipulate content from computers, laptop computers, tablet computers, cellular telephones and other mobile computing devices over WiFi or Ethernet networks to a computer connected to an electronic display panel, flat panel display, liquid crystal display, monitor, projector, display wall, or display table, e.g., a ThinkHub™ computer by T1V™. The mobile device be connected through a digitizer and connections or would be running a sharing application thereon to assist in connecting to, sharing, digitizing and streaming digital content with the display computer, e.g., an AirConnect™ App by T1V™. The sharing application may be a single application or may be separate application for each function, collectively referred to herein as a sharing application.

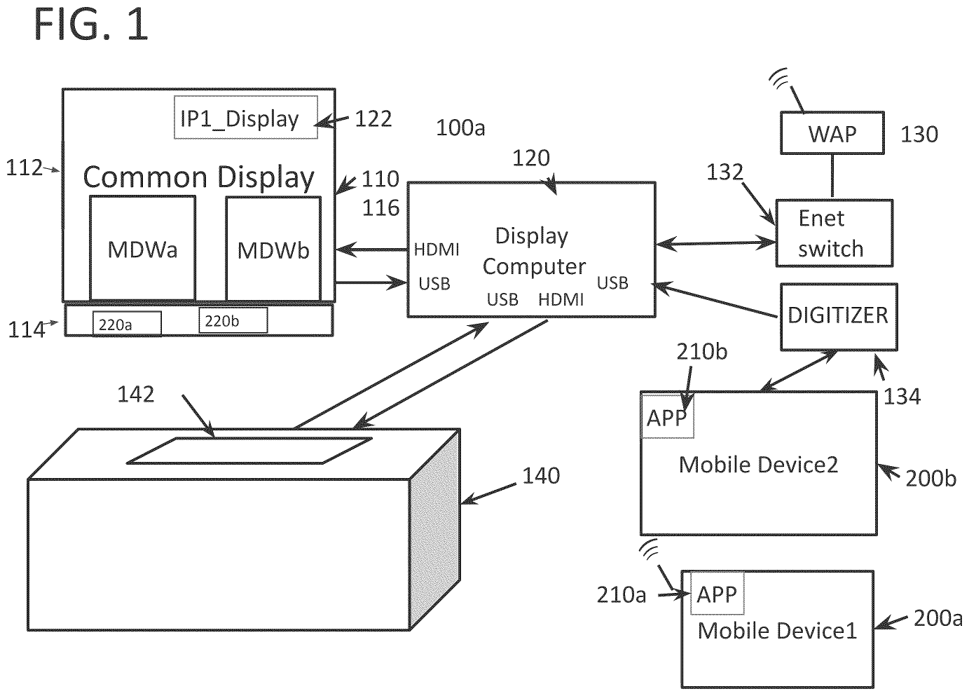

FIG. 1 illustrates a block diagram of a display system 100a interacting with one or more mobile devices 200a, 200b, and so forth. The display system 100a includes a Common Display 110, a Display Computer 120, and Ethernet switch 132 and a wireless router 130 serving as a wireless access point (WAP), all interconnected. The Common Display 110 may be an LCD display, LED display, or other monitor that is capable of having an electronic video signal as an input and converting the input to a visual image.

The Common Display 110 may include a display region 112 and a tray region 114, e.g., below the display region. As shown in FIG. 1, the Common Display may be a vertically mounted display, e.g., a wall display. The Common Display 110 may include a touch sensor 116, e.g., overlaying an entirety of the Common Display 110, that it is sensitive to touch inputs including taps and gestures. Additionally or alternatively, a non-touch gesture detector may be associated with the Common Display 110.

Information regarding a Machine Identifier 122 of the Display Computer 120 and the digital information to be displayed on the Common Display 110 may be sent from the Display Computer 120 to the Common Display 110. Digital information to be displayed may include data streamed from mobile devices, e.g., MobileDevice1, MobileDevice2, and so forth. This digital information can be within windows or Mobile Device Windows (MDWs), e.g., editable windows, or on the entire screen of display region 112 of the Common Display 110. In addition, there may be windows displaying contents from Mobile devices or other appropriate mobile device icons (MDI) 220a, 220b, e.g., a thumbnail of what is displayed on the mobile device, in the tray region 114 on the Common Display 110, e.g., at a lower region thereof. The tray region 114 may be a region on which the MDWs cannot be zoomed and pinched, annotated, and so forth, but may be dragged, tapped or tossed onto the display region 112, e.g., to open an MDW corresponding to the MDI, and/or to received MDWs from the display region 112 to transmit that MDW to the mobile device corresponding to the MDI.

Digital information from Mobile Device1 (200a) may be streamed from these Mobile Devices to the Display Computer 120 through the network. In FIG. 1, digital information may be streamed from the mobile devices through the WAP 130 to the Display Computer 120. In particular, a user of a MD may download a sharing application 210a thereon to assist in connecting to and sharing and streaming content with the Display Computer 120 wirelessly. Instructions for downloading the sharing application 210a may be readily viewable, e.g., on or adjacent the common display 110, or a region to be scanned, e.g., a barcode, quick response (QR) code, and so forth, using a mobile device QR, so that once scanned, the sharing application 210a, 210b could be downloaded. Once the sharing application 210a is downloaded, then a user can launch the sharing application 210a and then enter the Machine Identifier 122 associated common display 110. The Machine Identifier 122 may by an IP address or other alphanumeric code associated with the Display Computer 120. The Machine Identifier 122 may be simply displayed on the Common Display 110, in which case the user of the sharing application 210a may simply enter the Machine Identifier 122 when prompted by the sharing application 210a their Mobile Device. Alternatively, the Machine Identifier 122 may be automatically transferred to the Mobile Device either by displaying a QR code on the Common Display 110 or by transmitting through Bluetooth® or wireless communication. Versions of the sharing application 210a may be written for each common operating system

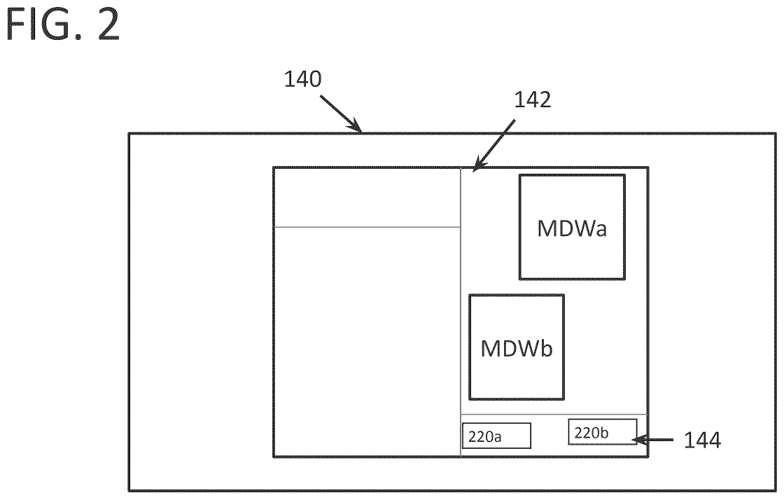

As illustrated in FIG. 1, embodiments are directed to use of a system with a vertically mounted display, e.g., a wall display, i.e., the Common Display 110, and a horizontally mounted display, e.g., a table display, i.e., Common Display 140 including a horizontal display region 142 and a tray region 144 (see FIG. 2). The particular configuration illustrated in FIG. 2 shows two windows at different orientations, as disclosed in U.S. Pat. No. 8,583,491, which is hereby incorporated by reference in its entirety for all purposes. Any of the embodiments disclosed herein may be used with one or more common displays at any desired orientation.

### Input Monitoring

When a mobile device 200b that does not have the sharing application downloaded thereon is to stream data to the Display Computer 120, the system 110a may also include a digitizer 134. Thus, in addition to connecting a MD, e.g., laptop computers, tablets, smart phones, and so forth, as a source using a high-frequency wireless local area network (Ethernet switch 132 and the WAP 130), a hardline input, e.g., high definition multimedia interface (HDMI) inputs or video graphics array (VGA) inputs, may be used to connect the Display Computer 120 and the MDs. Here, the MD outputs an analog signal to the digitizer 134 and the digitizer 134 generates the digital stream to be output to the Display Computer 120, rather than the MD streaming digital data to the Display Computer 120 directly.

An output of the digitizer 134 is connected to a Display Computer 120, e.g., to a USB port, running the vertical CD 110 and the horizontal CD 140. The output of the digitizer 134 is monitored and, when active, a new window may be opened on one or both CDs. One or both of the CDs may have a touch screen integrated therewith.

First, when the MD is first connected to the digitizer 134, the Display Computer 120 may display the MDI in the device tray 114 (144) and/or an MDW for that digitizer 134 in the display region 122 (142) on one or both CDs (110, 140).

Second, to determine if the digitizer 134 is active, i.e., receives a real signal from the source, the Display Computer 120 may monitor an output from the digitizer 134. When the output of the digitizer 134 is substantially uniform, e.g., when a standard deviation between pixels is below a predetermined threshold, it is assumed that there is no signal and the digitizer 134 is considered inactive. Particularly, when more than one digitizer 134, e.g., a digitizer for each MD to be connected to the Common Display(s), is connected to the Display Computer 120, don't want all MDWs to appear all of the time in the Common Display(s). When the standard deviation exceeds the threshold, the digitizer 134 may be considered active and a MDW and/or MDI may automatically open on one or both CD(s), e.g., both when the system is operating in the mirror mode discussed in the patent application noted above. This monitoring and control may also be used with mobile devices connected to the Display Computer 120 wirelessly over a network.

In the configuration illustrated in FIG. 1, there are touchable windows, e.g., MDWs, that may be resized, panned, zoomed, within a canvas that contain contents of source updated in realtime for both wireless and hardline connected sources (Mobile Devices). All operations disclosed in the patent application referenced above may be performed for the hardline and wireless connected sources. However, these touch inputs will not be sent back to the Mobile Device.

### Remote Gesture Control Using Hardline Inputs

Alternatively, a Mobile Device may be connected to the Display Computer 120 over a network using a server process running on the Mobile Device, e.g. remote desktop protocol (RDP). The Display Computer 120 logs into the Mobile Device on the Common Display 110 (140) using RDP. Then, the Display Computer 120 takes over control of the MD and the contents of the MD's screen within a MDW may be controlled by the Display Computer 120. The touch events on the Common Display 110 (140) controlled by the Display Computer 120 are sent to the MD to control the corresponding window in the MD. This may all be done within a MDW that can be resized, moved, and so forth. Audio signals may also be received from the MD and full touch events (not just mouse events) may be sent to the MD.

While some of this communication could be performed using a server process, e.g., virtual network computing (VNC), using VNC does not allow touch events to be communicated (only mouse events) and would not send audio from the source to the Display Computer 120, but RDP addresses these issues. However, an issue with RDP is that the session must be initiated from the CD and requires logging into the MD from the Display Computer 120 with the user name and password of the MD and entering the IP address of the MD. Then once it is initiated, the Mobile Device (source) goes to a login prompt and the video is only displayed on the CD and not the MD. Thus, another issue in using RDP is that the same thing cannot be seen in both places, i.e., the MD and the CD. RDP and VNC are server process that are always running on the MD and allows anyone to log in to your MD if you have the username and password and IP address of the MD.

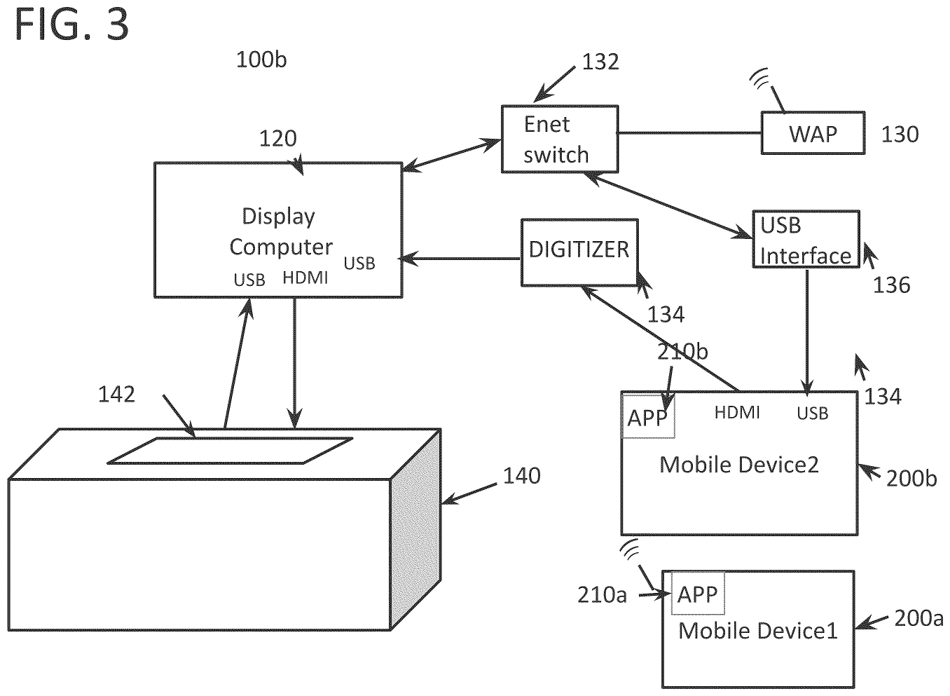

Another embodiment of a display system having a horizontal display is illustrated in a schematic block diagram of FIG. 3. As illustrated in FIG. 3, hardline remote control may be used to overcome these issues. As shown therein, a hardline, e.g., an hdmi cable, and a connection, e.g., a universal serial bus (USB), is plugged into the MD 200b. Another end of the hardline is connected to the digitizer 134 and another end of USB is connected to a USB interface box 136, which is connected to the Display Computer 120 through Ethernet or another connection interface, e.g., USB, on the Display Computer 120. The MD 200b and the Display Computer 120 cannot be directly connected by the USB cable because both will try to act like the host. The USB interface box 136 converts the USB data from the Display Computer 120 and sends it to the source (200b), and also simulates a touch screen so that the source (200b) thinks it is a touch screen, even if it is not. Then, all operations of FIG. 1 using RDP may be performed, but now the view of the screen associated with the source on the source and on the display of the display system 100b may be the same simultaneously.

Thus, embodiments include hardline connections between the source (mobile device) and the remote device (Display Computer 120). For example, an HDMI cable may transmit data from the user device to the Display Computer 120 and a USB cable may transmit data from Display Computer 120 to the MD. The MD then registers the USB cable as a touch input and thinks that there is a second display MD connected to the CD that is a touch display. Once registered, then touch commands can be sent over the USB cable (touch inputs sent through) from the Display Computer 120 (which outputs Adjusted Coordinates for the MD) and the inputs are treated on the MD as touch inputs from a touch display.

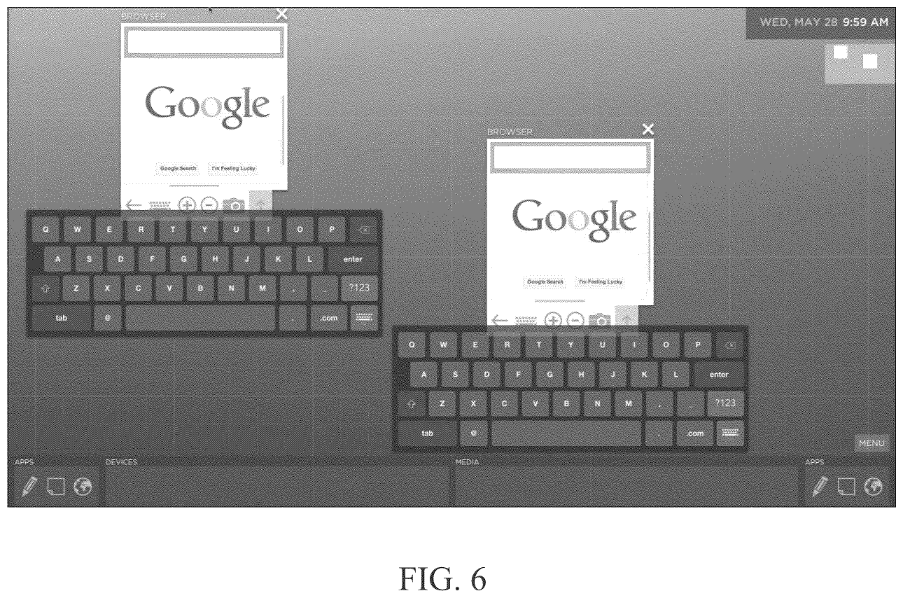

For example, if a spreadsheet program is running in the MDW on the CD, filling the MDW, when some cell on the CD is tapped, data on the Display Computer 120 is sent to the operating system of the MD, and a VKB (Virtual Keyboard) pops open on both the CD and the MD (see FIG. 6).

### Wireless Remote Gesture Control

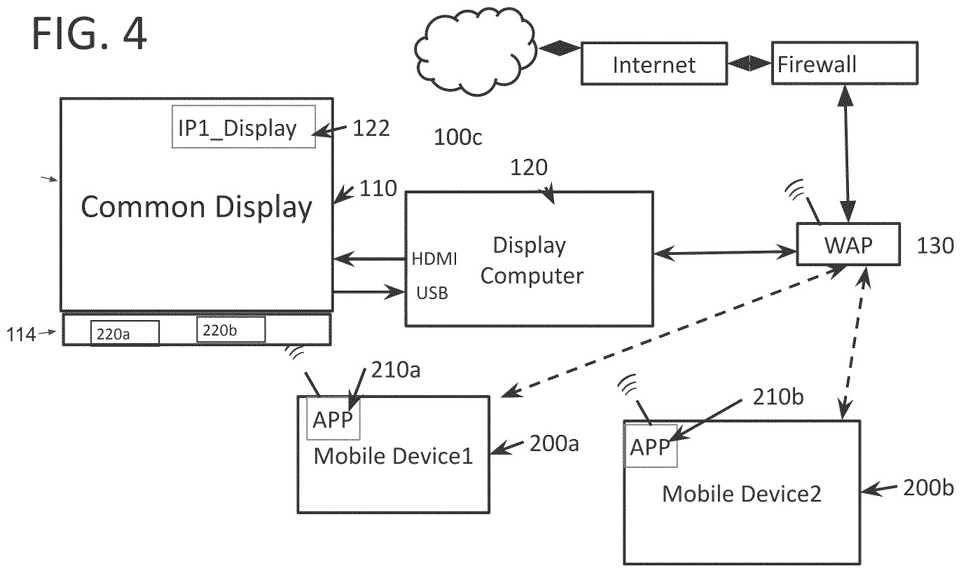

Another solution does not require hardline connection or activation from the CD, as illustrated in FIG. 4, in which a display system 100c includes only wireless connections between the MDs and the Display Computer 120. Here, the MDs will be running the sharing application 210a, 210b. However, with this solution, the MD still needs to realize that it is connected to the CD touch screen 116. For example, if the MD is a conventional computer with a keyboard and a mouse, the MD will assume that any touch inputs on any applications running on the computer are coming from the keyboard and/or mouse, so it may not respond to touch gestures. For example, clicking in a cell on a spreadsheet may not evoke the operating system (OS) of the MD or any virtual keyboard, as the OS of the MD will assume that a physical keyboard is present. However, when using wireless RGC, when a user gestures within a MDW, that information is transferred back to the MD, and can activate items on the mobile device.

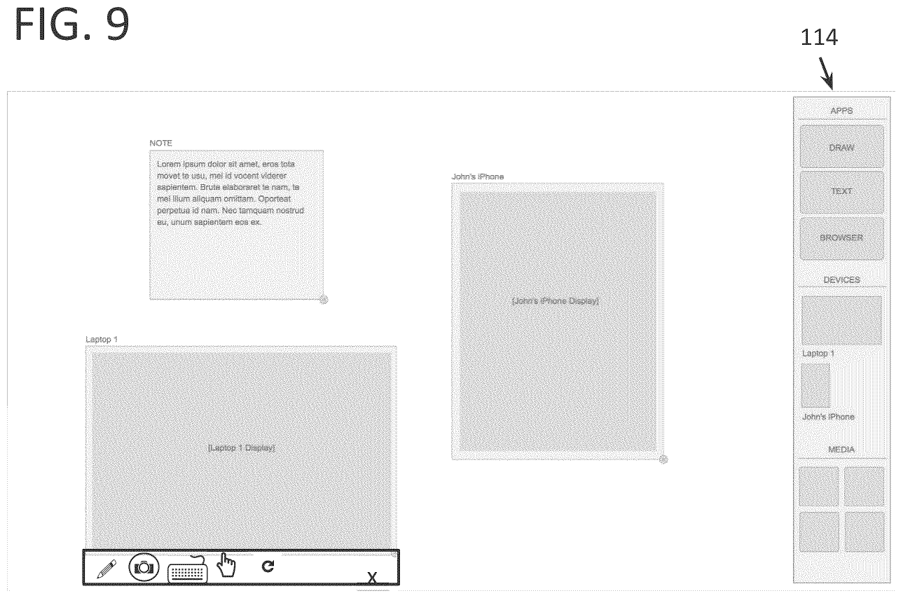

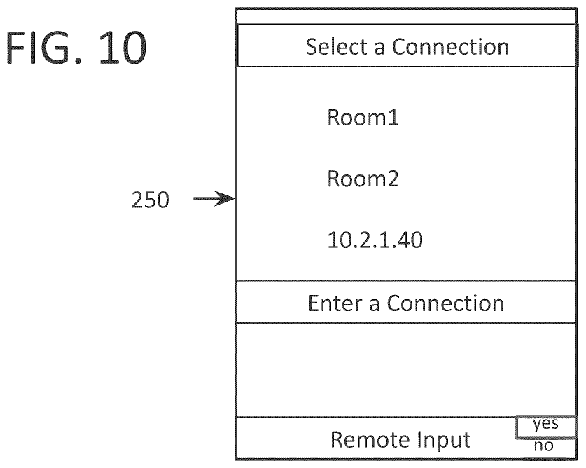

For example, suppose the MD is a laptop computer running Mac® OS. The sharing application on the MD is to mirror the contents of the MD onto the Common Display 110 and then may turn on RGC, e.g., by clicking or selecting a button within the sharing application (see FIG. 10). Then, an icon on their laptop to go to the Mac OS Finder may be activated such that the desktop is now displayed on their MD. Now a mirror image of what is on the laptop, e.g., the desktop, will be displayed in a corresponding MDW on the Common Display 110. Near the bottom of the MDW, will be an icon tray for launching apps and near the top will be the text menu items: the Apple® icon, Finder, File, Edit, etc. (just like on the laptop computer.) This icon tray is inside the MDW and is in addition to the tray 114 and the MDW tray discussed with respect to FIGS. 6 and 9.

If there is a tap within the MDW on an icon in the icon tray, near the bottom of the MDW, the application associated with that icon will launch on the MDW and on the MD. For example, suppose a spreadsheet program icon is tapped within the MDW. The spreadsheet program will then launch and take over the screen of the laptop computer and be mirrored on to the MDW within the collaboration software on the Display Computer 120. Files to open within spreadsheet program are activated from the CD touch screen 116. To type info into a cell, a keyboard may be needed. If so, a button within collaboration that evokes a keyboard may be provided in a MDW tray as explained below with reference to FIG. 6.

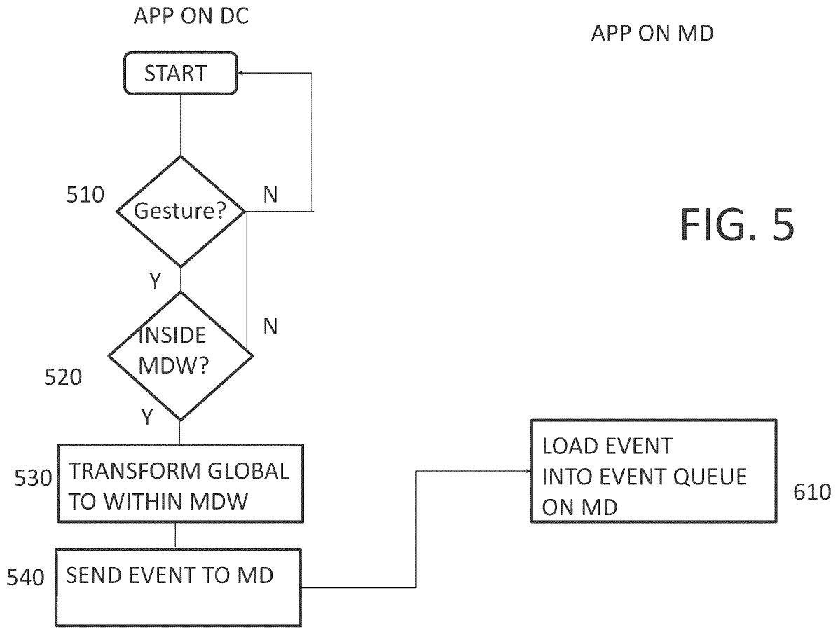

In a first mode (Gesture Relay Mode or GRM), the Display Computer will just relay any touch information received within the MDW to the MD, as illustrated in FIG. 5. To do this, the collaboration software on the Display Computer 120 will first detect information for the gesture from the display region 112 in operation 510. This gesture information may be generated by a gesture sensor on the display region 112, e.g., touch information detected by a touch sensor overlaying the display region 112, and may include the coordinates of the gesture with respect to the display region 112. The collaboration software on the Display Computer 120 will then determine if the gesture is located within or otherwise associated with a MDW in operation 520. If within the MDW, then the collaboration software on the Display Computer 120 will use the coordinates with respect to the entire Common Display 110 to determine Adjusted Coordinates for the MDW in operation 530. These Adjusted Coordinates can then be sent to the corresponding MD through the sharing application running thereon, as opposed to the USB interface used in the embodiment of FIG. 3. The connecting and sharing application on the MD can then notify the event listener in the OS on the MD that a gesture event has occurred in operation 610. It can then send the coordinates of the touch (the Adjusted Coordinates of the actual touch now become the actual coordinates on the display of the MD) and any other gesture information received.

In addition to GRM, the collaboration software can also display icons on the CD around the MDW to allow specific functions. Near the periphery of the MDW, the collaboration software may display a MDW tray containing various buttons as shown in FIG. 6. If any touches are received by the touch sensor for touches on the MDW tray, these touch coordinates will not be transmitted to the MD. Instead the collaboration software will take the inputs and implement an action. For example, if the keyboard icon is tapped, then the collaboration software will display a virtual keyboard. If a user then taps on a key on the virtual keyboard, the collaboration software on the Display Computer 120 will then send this keyboard information (the ASCII character tapped) to the MD through the connecting and sharing application on the MD. The sharing application on the MD will then send the keyboard information to the OS of the MD. The OS of the MD will then act as if the corresponding key on the physical keyboard of the MD was tapped and then send this keyboard information to whatever application is in focus on the MD at the time.

So if, for example, start up Excel with the RGC method from a CD 110. Then, a cell in the MDW is tapped. For example, if the contents of the cell are to be deleted, a “delete” icon on a virtual keyboard on the CD 110 could be tapped and the Display Computer 120 will perform the delete command in the MDW on the CD 110 and transmit the delete command back to the MD through the sharing application and the OS of the MD to thereby delete the contents of the cell on both the CD 110 and the MD.

In a second mode (Gesture Interpretation Mode, or GIM), the collaboration software running on the Display Computer 120, will first interpret touches or gestures before sending them to the MD, as illustrated in FIG. 6. In other words, the GIM include an additional operation 535 between operations 530 and 540. In particular, if the MD does not use the same input events as being monitored on the CD, e.g., does not have a touchscreen, the collaboration software may interpret a gesture to map to an input event recognized by the MD in operation 535.

The collaboration software on the Display Computer 120 may, for example, directly send any information received as single touch commands: mouse commands, such as drag, click, etc. However, if any multi-touch commands are received, then, instead of sending touch commands, the collaboration software on the Display Computer 120 may interpret the touch gestures into single touch commands in operation 535 and send the event as interpreted to the MD in operation 540.

For example, if a two finger zoom gesture is performed on the CD 110, the collaboration software on the Display Computer 120 will see this information and instead of sending the multi-touch data directly to the MD through the sharing application, it will note that it is a “zoom” gesture and instead of sending the information, will send the corresponding zoom gesture information to be implemented on the MD. If for example the MD is a Macbook and a tap occurs within the MDW on the CD 110, the collaboration software may send a mouse click for the location tapped. If a pinch gesture within the MDW on the CD 110 is performed, the collaboration software on the Display Computer 120 may, instead of sending the touch data, send event of the corresponding touch info as a gesture performed on the mousepad to the MD.

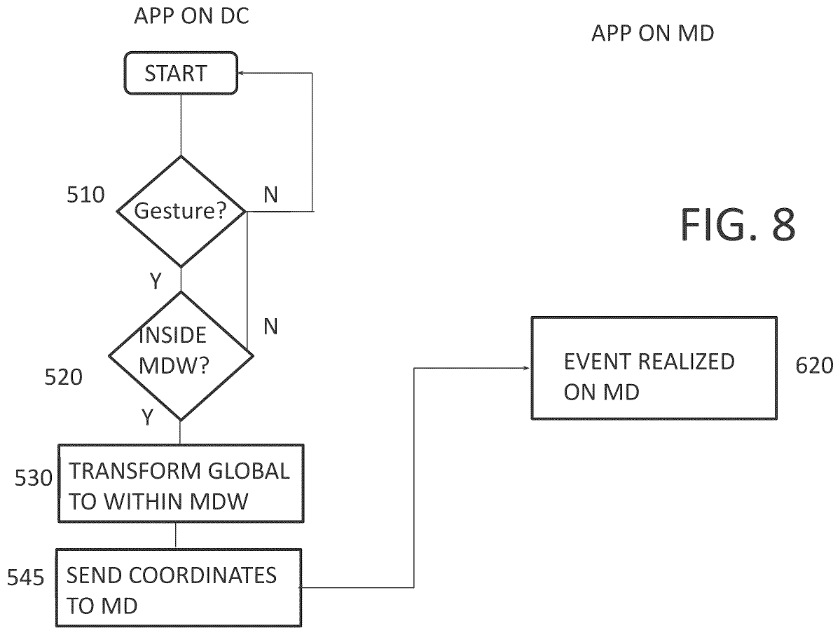

If the MDW corresponds to only a portion of the screen from the MD, as disclosed in the patent application referenced above, e.g., only one application or one window on a MD is transmitted to the Display Computer, then coordinate transformation for gesture detection in this MDW becomes a little more complicated. As illustrated in FIG. 8, once the Adjusted Coordinates are determined by the collaboration software on the Display Computer 120 in operation 530, then these Adjusted Coordinates can be sent to the sharing application running on the MD in operation 545. Then, the sharing application can then send these coordinates to the particular window in the MD that was sent to the Display Computer 120 or can send them to the OS with respect to the entire screen of the MD, adjusting for the current offset of the window on the MD to realize the event in operation 620.

Another issue is how to distinguish between gesture information to be sent to the MD or to be implemented on the CD 110. For example, suppose there is a web browser that is running on the MD and is displayed in the MDW on the CD 110, and then a drag gesture is performed on the MDW. As disclosed in a patent application referenced above, the drag could move the MDW or it could annotate on top of the MDW. Now, with RGC, this drag could additionally have the touch info sent to the sharing application running on the MD, which would send the touch data to the OS of the MD, which would then send the data to the web browser, which would perform a pan of the data located within the web browser. (For example, pan to a different location on a map.) So whether or not gesture information is to be sent to the MD running RGC needs to be determined. This may be implemented in the same manner as disclosed in U.S. patent application Ser. No. 14/540,946, filed on Nov. 13, 2014 and entitled “Simultaneous Input System for Web Browsers and Other Applications,” now U.S. Pat. No. 9,596,319, which is hereby incorporated by reference in its entirety for all purposes, which includes icons in a MDW tray, to allow users to select a pencil for annotation, a hand for pan, a camera to take a snapshot, a keyboard to bring up a virtual keyboard, or to remove the tray entirely. The system may include a snapshot icon adjacent the MDW, when the snapshot icon is activated, the computer is configured to display a static image of the first window as a new window. When, an icon that is not CD centric, here a reload icon, in the tray associated with the MDW to indicate RGC or if the tray around a MDW is used and none of the CD-centric icons are selected, then the gesture is sent to the MD, as illustrated in FIG. 9. For example, as illustrated in FIG. 11, when an MDW is activated, here John's iPhone® window, the MDW may now include a snapshot tool, indicated by a camera icon, and/or a draw tool. As illustrated in FIG. 12, when the camera icon of the window is activated, a snapshot of that window is provided in the display region,

Alternatively or additionally, the sharing application on the MD may include an option to turn on RGC or not, as illustrated in FIG. 10, which illustrates a screen 250 that may appear when starting the connecting and sharing application on the MD. Here, a user would be prompted to select which display to be connected with. These options may include a name of a room in which the common display 110 is located, a nickname for the common display that is visually apparent, the machine identifier of the common display that is visually apparent, and so forth, as well as on option to allow remote input, i.e., RGC. The screen 250 for selection may look the same regardless of the operating system of the mobile device running the sharing application. Thus, RGC may be controlled by either the Display Computer 120 or the MD. The default for using RGC may be to enable RGC.

By way of summation and review, in accordance with one or more embodiments, a display computer controlling a common display may control a display on a mobile device connected thereto using gestures associated with the common display on which an image from the mobile device displayed. This may include using hardline or wireless event transmission and, as a sharing application on the mobile devices may be written for an operating system on that mobile device, and the collaboration software is written for the operating system of the display computer, the mobile devices do not need to be using the same operating system as the display computer or as one another. Further, in accordance with one or more embodiments a data stream from a mobile device may be monitored by the display computer to determine whether active.

Embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of this disclosure.

The methods and processes described herein may be performed by code or instructions to be executed by a computer, processor, manager, or controller. Because the algorithms that form the basis of the methods (or operations of the computer, processor, or controller) are described in detail, the code or instructions for implementing the operations of the method embodiments may transform the computer, processor, or controller into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

Example embodiments have been disclosed herein, and although specific terms are employed, they are used and are to be interpreted in a generic and descriptive sense only and not for purpose of limitation. For example, while mobile device have been used as examples of remote devices, other fixed remote devices may employ the connecting and sharing applications described herein. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A system, comprising:
a first display having a first display region;
a first computer that drives the first display, the first computer to run collaboration software; and
a first mobile device to run a sharing application,
wherein a wireless connection is established between the first mobile device and the first computer through the sharing application on the first mobile device and collaboration software on the first computer, and an identifier associated with the first computer is entered on the first mobile device, wherein
the first mobile device has a video signal displayed on its screen, the sharing application on the first mobile device converts this video signal to a first digital data stream and sends the first digital data stream to the first computer,
the first computer receives the first digital data stream and outputs the first digital data stream to a first mobile device window on the first display region in a first display mode,
when the collaboration software on the first computer detects a window gesture within the first mobile device window on the first display associated with the first digital data stream, the first computer alters the first mobile device window on the first display region to be in a second display mode that includes first icon tray adjacent thereto in the first display region, the first icon tray including a snapshot icon and at least one of a keyboard icon, an annotation icon, and a pan icon, wherein actions performed in the first icon tray are only performed for the first mobile device window, and
wherein, in response to selection of the snapshot icon in the first icon tray for the first mobile device window, open a new window in the first display region that displays a snapshot of the first mobile device window.
